(19) United States
(12) Patent Application Publication
(10) Pub. No.: US 2020/0187521 A1
(43) Pub. Date: Jun. 18, 2020

(54) Food Composition and Methods of Making and Using the Same

(71) Applicant: Warouj KACHICHIAN, Rolling Hills Estates, CA (US)

(72) Inventor: Warouj KACHICHIAN, Rolling Hills Estates, CA (US)

(21) Appl. No.: 16/681,657

(22) Filed: Nov. 12, 2019

Related U.S. Application Data
(60) Provisional application No. 62/780,858, filed on Dec. 17, 2018.

(51) Int. Cl. A23G 3/32; A23L 27/30; A23L 33/21

(52) U.S. Cl. CPC A23G 3/32; A23V 2002/00; A23L 33/21; A23L 27/34

(57) ABSTRACT

A method for preparing a caramelized product, a kit for a caramelizable composition, a food product comprising a caramelized composition, and a caramelized sauce are disclosed. The caramelized product may be a caramel, a brittle, or a syrup. The method includes mixing a sugar alcohol and/or a non-metabolizable sugar and a dietary fiber to form a mixture, and heating the mixture at a temperature and for a length of time sufficient to caramelize the mixture. The kit includes a container and a sugar alcohol/non-metabolizable sugar and a dietary fiber in the container. The sugar alcohol/non-metabolizable sugar and the dietary fiber are present in a ratio by weight or by volume such that a mixture thereof, when heated to a temperature of from 270° F. to 350° F. for a sufficient length of time, is caramelized.

### RELATED APPLICATION(S)

The present application claims priority to U.S. Provisional Pat. Appl. No. 62/780,858, filed Dec. 17, 2018 (Atty. Docket No. VK-001-PR), incorporated herein by reference in its entirety.

### FIELD OF THE INVENTION

The present invention generally relates to food product substitutes. More specifically, embodiments of the present invention pertain to a caramelizable composition that can be used as an alternative to table sugar (i.e., sucrose) and methods of manufacturing and using the same.

### DISCUSSION OF THE BACKGROUND

With the increase in obesity and other health problems related to the consumption of table sugar (i.e., sucrose), there is a trending need to find healthier alternatives. While there has been some progress made in this undertaking, most food products are still manufactured using sucrose as the main sweetening component.

Artificial sweeteners have inundated the marketplace as a result of this effort to minimize the consumption of sucrose and the health-related issues stemming from its use. A variety of high intensity, reduced calorie sweeteners have been developed to replace sugar. Some leading examples of reduced calorie sweeteners are aspartame and acesulfame. Acesulfame in particular is shown to be 200 times sweeter than sugar, but with no caloric value. Although these products can replace sugar, they are unable to mimic some of its chemical and physical properties.

Other artificial sweetening agents containing polyols such as xylitol and erythritol are particularly useful as a “no calorie” substitute for sucrose. In addition, studies have shown xylitol to be a promising deterrent for tooth decay and may also reverse the course of dental decay if detected early.

In spite of these advantages, there are market studies that show some concerns with the use of artificial sweetening products. In particular, consumer have complained of lingering chemical aftertaste as a result of adding the artificial sweetener to food or beverage. Moreover, in spite of the substantial advantages attending the sweetening of foodstuffs with sugar alcohols (e.g., xylitol, sorbitol, mannitol, maltitol, etc.) and other artificial sweetening agents [e.g., monosaccharides, polysaccharides], the ingestion of higher doses of such sweetening agents and the lack of digestive adaptation to such sweetening agents in sensitive individuals may result in unpleasant side effects including diarrhea and symptoms associated with diarrhea. These side effects are particularly pronounced when a foodstuff containing one or more such sweetening agents is consumed on an empty stomach, or when the foodstuff in question is a beverage.

U.S. Pat. No. 5,106,967 discloses 5-C-hydroxymethylhexose compounds, derivatives thereof that may exhibit sugar-like functionality when used in food compositions, and sugar substitute compositions and food compositions containing these compounds and their derivatives. The derivatives include stereoisomers, di-, tri-, and polysaccharides, alkyl glycosides, polyol, and alditol derivatives.

U.S. Pat. No. 6,423,358 discloses a low calorie, palatable fiber-containing, table sugar substitute containing inulin and a high intensity sweetener, where the inulin and high intensity sweetener are present in a proportion such that, on a volume: volume basis, the table sugar substitute provides approximately the same sweetness as sucrose. U.S. Pat. No. 7,186,431 discloses a composition for sweetening foodstuffs that comprises at least one sweetening agent (e.g., a polyol, monosaccharide, disaccharide, trisaccharide, or combination thereof) and inulin, which comprises at least about 25 percent by weight of the combination of sweetening agent and inulin.

U.S. Pat. No. 7,182,968 discloses a composition containing psyllium fiber and xylitol. The composition is in powdered, liquid or product form. In powdered form, the composition is used for producing confectionery products, beverages, baked good products, bakery products, snack bars and similar foodstuff products. In product form, the composition is used to produce confectionery products, baked good products, bakery products, snack bars and similar foodstuff products. The fiber is preferably psyllium fiber. However, the psyllium fiber may be substituted with fruit fiber and derivatives including pectin; seaweed gums and derivatives, including carrageenan, agar and alginates; cellulose and derivatives; cereal grain fibers, including corn, wheat, oat, rice, barley and soy; fructooligosaccharides and their derivatives; seed gums, including guar and locust bean; tree gums, including karaya, tragacanth and acacia; xantham gum; vegetable fiber, including pea and legumes; and potato fiber. Suitable natural flavorings, which can be added to the composition containing xylitol and fiber, include nuts, green vegetables and legumes, carrots, chocolate, cocoa, vanilla, orange, lemon, lime, grapefruit, peach, apricot, nectarine, strawberry, blueberry, raspberry, peppermint, coffee, cinnamon, mocha, tomato, herbs (green tea, ginger, ginseng, etc.) and the like.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF INVENTION

In one aspect, the present invention relates to a method for preparing a caramelized product comprising mixing (i) a sugar alcohol and/or a non-metabolizable sugar and (ii) a dietary fiber to form a mixture, and heating the mixture at a temperature and for a length of time sufficient to caramelize the mixture. In some embodiments, the method comprises mixing the sugar alcohol and the dietary fiber. In other embodiments, the method comprises mixing the non-metabolizable sugar and the dietary fiber.

The sugar alcohol may be selected from the group consisting of erythritol, threitol, xylitol, arabitol, ribitol, mannitol, sorbitol, galactitol, fucitol, iditol, inositol, maltitol, isomalt, lactitol, maltotriitol and maltotetraitol. For example, the sugar alcohol may be erythritol.

The non-metabolizable sugar may be selected from the group consisting of allulose, mannose, sorbose, xylose, arabinose, tagatose (hexulose), palatinose and turanose. For example, the non-metabolizable sugar may be allulose.

The dietary fiber may be selected from the group consisting of inulin, psyllium fiber, fruit fibers, seaweed gums and derivatives thereof, cellulose and derivatives thereof, cereal grain fibers, fructooligosaccharides and derivatives thereof, seed gums, tree gums, xantham gum, vegetable fibers, and potato fiber. For example, the dietary fiber may be or comprise inulin, cellulose, a pectin, or a hemicellulose.

Typically, the temperature is from 270° F. to 350° F., or any temperature or range of temperatures therein (e.g., 270° F. to 320° F., 290° F. to 350° F., 300° F. to 325° F., etc.). the length of time sufficient to caramelize the mixture depends on the components in the mixture and the amounts of the components.

In typical embodiments, the mixture contains the sugar alcohol and/or the non-metabolizable sugar and the dietary fiber in a weight or volume ratio of from 1:99 to 99:1 of (i) the sugar alcohol and/or the non-metabolizable sugar to (ii) the dietary fiber. For example, the mixture may contain the sugar alcohol and/or the non-metabolizable sugar and the dietary fiber in a weight or volume ratio of from 10:90 to 90:10 of (i) the sugar alcohol and/or the non-metabolizable sugar to (ii) the dietary fiber, or any ratio or range of ratios between 1:99 to 99:1 by weight or volume. The densities of the sugar alcohols, the non-metabolizable sugars and the dietary fibers are generally similar, so the results generally do not vary significantly when the ratio is by weight or by volume.

In some embodiments of the method, the sugar alcohol and/or non-metabolizable sugar and the dietary fiber are mixed without water or other materials that are liquid at room temperature (the so-called “dry” method). In such embodiments, the mixture may contain the sugar alcohol and/or the non-metabolizable sugar and the dietary fiber in a weight or volume ratio of from 30:70 to 70:30 (e.g., from 40:60 to 60:40 or any other ratio or range of ratios therein) of (i) the sugar alcohol and/or the non-metabolizable sugar to (ii) the dietary fiber. Use of the dry method generally results in a caramel.

In other or further embodiments, the sugar alcohol and/or the non-metabolizable sugar and the dietary fiber are further mixed with a foodstuff prior to heating the mixture. For example, the foodstuff may comprise one or more nuts, grains, and/or fruits (e.g., chopped nuts, whole nuts, whole grains, chopped dry fruits or whole dry fruits). In the dry method, mixing such foodstuffs with the sugar alcohol and/or the non-metabolizable sugar and the dietary fiber results in a brittle.

In alternative embodiments, the sugar alcohol and/or the non-metabolizable sugar and the dietary fiber are further mixed with water and/or another liquid (e.g., a fat or oil) to form the mixture (the so-called “wet” method). In such embodiments, the mixture may contain the sugar alcohol and/or the non-metabolizable sugar and the dietary fiber in weight or volume ratio of from 20:80 to 50:50 (e.g., from 25:75 to 40:60 or any other ratio or range of ratios therein) of (i) the sugar alcohol and/or the non-metabolizable sugar to (ii) the dietary fiber. The water and/or other liquid may be mixed in an amount in the range of from 1 part to 50 parts (or any value or range of values therein) per 100 parts of the mixture, by weight or volume. Use of the wet method generally results in a syrup.

In further embodiments, the method may further comprise aerating the mixture. Aerating the mixture may comprise bubbling air through the heated mixture, either during or after heating.

In even further embodiments, the sugar alcohol and/or the non-metabolizable sugar and the dietary fiber may be further mixed with a sweetening intensifier, an organic acid (and/or a salt thereof), and/or a preservative. The sweetening intensifier may be selected from the group consisting of acesulfame, sucralose, saccharin, cyclamate, stevia, monkfruit and extracts (including powders) thereof, glycine and aspartame. The organic acid may be selected from the group consisting of citric acid (e.g., lemon, lime or orange juice), acetic acid (e.g., vinegar), lactic acid, malic acid, tartaric acid, fumaric acid, oxalic acid, sorbic acid, ascorbic acid, benzoic acid, tannic acid, caffeotannic acid, and salts thereof (e.g., sodium, potassium or calcium salts thereof). To the extent that the organic acid or salt thereof is not present, is not a preservative, or does not provide a desired level of preservation, a preservative such as sodium phosphate (e.g., monobasic, dibasic and/or tribasic sodium phosphate; NaH₂PO₄, Na₂HPO₄ and/or Na₃PO₄) may be added.

Another aspect of the present invention relates to a kit for a caramelizable composition, comprising a container, a sugar alcohol and/or a non-metabolizable sugar, and a dietary fiber. The sugar alcohol and/or non-metabolizable sugar and the dietary fiber are present in amounts such that a ratio by weight or by volume of the sugar alcohol and/or non-metabolizable sugar in the container to the dietary fiber in the container forms a mixture that, when heated to a temperature of from 270° F. to 350° F. for a sufficient length of time, is caramelized. Most embodiments of the kit comprise an amount of the sugar alcohol and/or the non-metabolizable sugar and an amount of the dietary fiber such that a ratio of the amount of the sugar alcohol and/or the non-metabolizable sugar to the amount of the dietary fiber is from 10:90 to 90:10 by weight or volume.

Some embodiments of the kit comprise the sugar alcohol, and other embodiments of the kit comprise the non-metabolizable sugar. As for the method, the sugar alcohol in the kit may be selected from the group consisting of erythritol, threitol, xylitol, arabitol, ribitol, mannitol, sorbitol, galactitol, fucitol, iditol, inositol, maltitol, isomalt, lactitol, maltotriitol and maltotetraitol, and the non-metabolizable sugar may be selected from the group consisting of allulose, mannose, sorbose, xylose, arabinose, tagatose (hexulose), palatinose and turanose.

The dietary fiber in the kit may be selected from the group consisting of inulin, psyllium fiber, fruit fibers, seaweed gums and derivatives thereof, cellulose and derivatives thereof, cereal grain fibers, fructooligosaccharides and derivatives thereof, seed gums, tree gums, xantham gum, vegetable fibers, and potato fiber. For example, the dietary fiber may comprise inulin, cellulose, a pectin, or a hemicellulose.

In some embodiments of the kit, the temperature at which the mixed components of the kit caramelize is from 270° F. to 320° F. In other embodiments, the temperature is from 290° F. to 350° F., or from 300° F. to 325° F.

Some embodiments of the kit consist essentially of the sugar alcohol and/or non-metabolizable sugar and the dietary fiber. Such embodiments of the kit may comprise an amount of the sugar alcohol and/or the non-metabolizable sugar and an amount of the dietary fiber such that the ratio of the amount of the sugar alcohol and/or the non-metabolizable sugar to the amount of the dietary fiber is from 30:70 to 70:30 (e.g., from 40:60 to 60:40 or any other value or range of values therein) by weight or volume.

Similar to the method, some embodiments of the kit further comprise a foodstuff in the container. The foodstuff may comprise one or more nuts, grains, and/or fruits, such as chopped nuts, whole nuts, whole grains, chopped dry fruits or whole dry fruits. Alternatively, the foodstuff may be selected from the group consisting of flours, dry eggs, dry dairy products, fruits, nuts, flavoring agents, fats, and oils. For example, when the foodstuff includes flour, the kit may further comprise yeast. Alternatively, when the foodstuff includes a fat and/or oil, the kit may further comprise an emulsifying agent.

In some embodiments, the container includes (i) the sugar alcohol and/or non-metabolizable sugar and the dietary fiber and (ii) the foodstuff in separate packages. Alternatively or additionally, (i) the sugar alcohol and/or a non-metabolizable sugar and (ii) the dietary fiber may be in separate packages in the container. For example, the sugar alcohol and/or non-metabolizable sugar may be in a first package in the container, the dietary fiber may be in a second package in the container, and (when present) the foodstuff may be in a third package in the container. Alternatively, the sugar alcohol and/or non-metabolizable sugar and the dietary fiber may be in a first package in the container, and the foodstuff may be in a second package in the container. In some embodiments, each of the packages may comprise a plastic or paper bag, a plastic or glass bottle, jar, tub, etc.

The container may comprise a box, a tin, a tub or a bag. When the container comprises the box, the box may comprise paperboard, cardboard or plastic. In some examples, the box may comprise a tray and a lid. Alternatively, the box may comprise a regular slotted container. When the container comprises the tin, the tin may comprise a metal. For example, the tin may comprise a metal tray and a metal lid. When the container comprises the tub, the tub may comprise a plastic. For example, the tin may comprise a plastic tray and a plastic lid. When the container comprises the bag, the bag may comprise paper, plastic or a combination thereof.

In some embodiments (e.g., designed or configured to make a syrup), the ratio of the amount of the sugar alcohol and/or the non-metabolizable sugar to the amount of the dietary fiber may be from 20:80 to 50:50 (e.g., from 25:75 to 40:60 or any value or range of values therein) by weight or volume.

As for the method, the kit may further comprise a sweetening intensifier and/or an organic acid in the container. The sweetening intensifier and the organic acid may independently be in the same package as one of the sugar alcohol, the non-metabolizable sugar, the dietary fiber or (when present) the foodstuff, or in a separate package. The sweetening intensifier may be selected from the group consisting of acesulfame, sucralose, saccharin, cyclamate, stevia, monkfruit and extracts thereof, glycine, and aspartame. The organic acid may be selected from the group consisting of citric acid, acetic acid, lactic acid, malic acid, tartaric acid, fumaric acid, oxalic acid, sorbic acid, ascorbic acid, benzoic acid, tannic acid and caffeotannic acid.

Yet another aspect of the present invention relates to a caramelized composition comprising a sugar alcohol and/or a non-metabolizable sugar and a dietary fiber, where the caramelized composition has a level of browning and/or a brittleness associated with an otherwise identical caramelized composition including an amount of sucrose equivalent to amounts of the sugar alcohol and/or non-metabolizable sugar and the dietary fiber in the caramelized composition. For example, the level of browning of the caramelized composition may at least 50% (e.g., at least 75%, or any percentage or range of percentages greater than 50%) of the otherwise identical caramelized composition. Alternatively or additionally, the brittleness of the caramelized composition may be at least 50% (e.g., at least 75%, or any percentage or range of percentages greater than 50%) of the otherwise identical caramelized composition.

The amount of sucrose in the otherwise identical caramelized composition may be an amount providing a sweetness equivalent or equal to the sweetness of the amounts of the sugar alcohol and/or non-metabolizable sugar and the dietary fiber in the caramelized composition. In other words, the amount of sucrose in the otherwise identical caramelized composition may be that corresponding to the equivalent sweetness of the amounts of the sugar alcohol and/or non-metabolizable sugar and the dietary fiber in the caramelized composition. Alternatively, the amount of sucrose in the otherwise identical caramelized composition may be equal to an amount of the sugar alcohol and/or non-metabolizable sugar and the dietary fiber in the caramelized composition by volume or weight. Also, to compare the level of browning and/or the brittleness, the otherwise identical caramelized composition should be processed identically (e.g., heated to the same temperature for the same length of time) to the caramelized composition.

Similar to the present method and the present kit, the caramelized composition in the present food product may consist essentially of the sugar alcohol and/or non-metabolizable sugar and the dietary fiber. The food product and/or caramelized composition in such cases may comprise a caramel. Alternatively, the food product may comprise a brittle. In some embodiments, the food product and/or caramelized composition consists essentially of the sugar alcohol and the dietary fiber. In other embodiments, the food product and/or caramelized composition consists essentially of the non-metabolizable sugar and the dietary fiber. In all such embodiments, the caramelized composition may comprise an amount of the sugar alcohol and/or the non-metabolizable sugar and an amount of the dietary fiber such that a ratio of the amount of the sugar alcohol and/or the non-metabolizable sugar to the amount of the dietary fiber is from 30:70 to 70:30 (e.g., from 40:60 to 60:40, or any value or range of values therein) by weight or volume. When the food product comprises a brittle, the brittle may further comprise one or more nuts, grains, and/or fruits, such as chopped nuts, whole nuts, whole grains, chopped dry fruits or whole dry fruits.

Also similar to the present method and the present kit, the caramelized composition in the present food product may further comprise water and/or another liquid (e.g., a fat and/or oil). In such embodiments, the caramelized composition may comprise a syrup. Such caramelized compositions may comprise an amount of the sugar alcohol and/or the non-metabolizable sugar and an amount of the dietary fiber, and a ratio of the amount of the sugar alcohol and/or the non-metabolizable sugar to the amount of the dietary fiber is from 20:80 to 50:50 (e.g., from 25:75 to 40:60, or any value or range of values therein) by weight or volume.

In some embodiments, the food product may further comprise a foodstuff. As for the present method and kit, the foodstuff may be selected from the group consisting of flours, eggs, dairy products, fruits, nuts, flavoring agents, fats, and oils. When the food product includes one or more flours, the caramelized product may comprise a baked good, and may further comprise yeast, water, a fat, an oil, a dairy product, etc. When the foodstuff is a fat or oil, the caramelized product may further comprise an emulsifying agent.

Similar to the present method and kit, the food product and/or caramelized composition may comprise the sugar alcohol. The sugar alcohol may be selected from the group consisting of erythritol, threitol, xylitol, arabitol, ribitol, mannitol, sorbitol, galactitol, fucitol, iditol, inositol, maltitol, isomalt, lactitol, maltotriitol and maltotetraitol. Alternatively, the food product and/or caramelized composition may comprise the non-metabolizable sugar. The non-metabolizable sugar may be selected from the group consisting of allulose, mannose, sorbose, xylose, arabinose, tagatose, palatinose and turanose.

As for the present method and kit, the dietary fiber may be selected from the group consisting of inulin, psyllium fiber, fruit fibers, seaweed gums and derivatives thereof, cellulose and derivatives thereof, cereal grain fibers, fructooligosaccharides and derivatives thereof, seed gums, tree gums, xantham gum, vegetable fibers, and potato fiber. For example, the dietary fiber may comprise inulin, cellulose, a pectin, or a hemicellulose.

In further embodiments, the food product and/or caramelized composition may further comprise a sweetening intensifier and/or an organic acid. The sweetening intensifier may be selected from the group consisting of acesulfame, sucralose, saccharin, cyclamate, stevia, monkfruit and extracts thereof, glycine, and aspartame, and the organic acid is selected from the group consisting of citric acid, acetic acid, lactic acid, malic acid, tartaric acid, fumaric acid, oxalic acid, sorbic acid, ascorbic acid, benzoic acid, tannic acid and caffeotannic acid.

A still further aspect of the present invention relates to a packaged food product, comprising the present food product and a container including the food product. The container may comprise a box, a tin, a bag, a jar, a tub, a bottle or a jug. When the container comprises the box, the box may comprise paperboard, cardboard or plastic. When the container comprises the tin, the tin may comprise a metal. For example, the tin may comprise a metal tray and a metal lid. When the container comprises the jar, the jar may comprise a plastic, a glass, a ceramic, and/or a metal. For example, the jar may comprise a body with an opening or mouth (which may be surrounded by a screw thread) and a lid configured to seal the opening or mouth (e.g., by screwing on to the screw thread). When the container comprises the tub, the tub may comprise a plastic. For example, the tin may comprise a plastic tray and a plastic lid. When the container comprises the bag, the bag may comprise paper, plastic or a combination thereof. When the container comprises the bottle (e.g., when the caramelized product is a syrup), the bottle may comprise a glass or plastic body and a cap. The container may be of a size suitable for retail/consumer products, wholesale products or wholesale markets, the restaurant, food service and/or health care industries, etc.

Yet another aspect of the present invention relates to a caramelized sauce, comprising (i) a sugar alcohol and/or a non-metabolizable sugar, (ii) a dietary fiber, (iii) water, and (iv) one or more thickeners, colorants and/or flavoring agents adapted to impart one or more characteristics of caramelization to the caramelized sauce. The sugar alcohol and/or non-metabolizable sugar and the dietary fiber may be present in amounts such that the ratio by weight or by volume of (i) the sugar alcohol and/or non-metabolizable sugar to (ii) the dietary fiber is as described elsewhere herein. The sauce may be further characterized as having a density and/or viscosity less than that of a syrup, but greater than that of water.

The method of making a sauce may comprise combining (i) a sugar alcohol and/or a non-metabolizable sugar, (ii) a dietary fiber, (iii) water, and (iv) one or more thickeners, colorants and/or flavoring agents adapted to impart one or more characteristics of caramelization to the caramelized sauce, then heating the combined ingredients to a temperature and for a length of time sufficient to make the sauce. As for the sauce itself, the sauce may have a density and/or viscosity less than that of a syrup, but greater than that of water.

The present invention advantageously provides a caramelizable mixture of a sugar alcohol and/or non-metabolizable sugar and a dietary fiber and methods for making the same. The caramelizable mixture can mimic the sweetening, browning and brittleness qualities of table sugar (sucrose), without the unwanted calories and/or other health risks associated with table sugar. By varying the temperature at which the caramelizable mixture is heated, a variety of color and brittleness properties can be achieved for various intended purposes. These and other advantages of the present invention will become readily apparent from the detailed description below.

### BRIEF DESCRIPTION OF THE DRAWINGS

FIG. 1 shows a graph representing the brittleness of an exemplary composition made in accordance with the present invention as a function of temperature.

FIG. 2 shows a graph representing the brittleness of a similar composition made using sucrose as a function of temperature.

FIG. 3 shows a graph representing the color and/or browning of an exemplary composition made in accordance with the present invention as a function of temperature.

FIG. 4 shows a graph representing the color and/or browning of a similar composition made using sucrose as a function of temperature.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

For the sake of convenience and simplicity, the terms “volume” and “weight” are, in general, interchangeable and may be used interchangeably herein, but are generally given their art-recognized meanings. Wherever one such term is used, it also encompasses the other terms. Similarly, for convenience and simplicity, the terms “part,” “portion,” and grammatical variations thereof may be used interchangeably herein, but are generally given their art-recognized meanings, and wherever one such term is used, it also encompasses the other terms. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

As used herein, a “non-metabolizable” sugar is not necessarily a sugar that cannot be metabolized. Rather, a non-metabolizable sugar is one that is metabolized by a typical human (i.e., without a genetic sugar-processing condition or disease, such as diabetes, glucose-galactose malabsorption, or phenylketonuria) significantly more slowly than a sugar in a common or conventional human metabolic pathway, such as sucrose, glucose, galactose or fructose.

Embodiments of the present invention may comprise or result in a caramelized or caramelizable composition having a powder, granular, crystalline and/or fluid form. Furthermore, embodiments of the present invention may (i) contribute to the textural and rheological properties of food, (ii) reduce blood sugar and blood sugar fluctuations, and (iii) increase the content of fiber and/or prebiotics in certain foods and food products where it might otherwise be difficult or impossible to do so. For example, the present caramelized or caramelizable composition has binding properties similar to sucrose (e.g., in a snack bar, candy or brittle), and can be used as a unit volume-for-unit volume or unit mass-for unit mass replacement for similar caramelized or caramelizable sucrose-based compositions.

Embodiments of the present invention may also provide antioxidants and/or antioxidant activity to certain foods and food products, and may provide certain foods and food products with no glycemic load, which may help with weight loss and appetite suppression. Furthermore, certain embodiments of the present invention may reduce oral plaque and improve oral health, reduce fat usage (in some applications, up to 50%), and improve calcium absorption for better bone health.

The invention, in its various aspects, will be explained in greater detail below with regard to exemplary methods for caramelizing a composition comprising a sugar alcohol and/or a non-metabolizable sugar and a dietary fiber, exemplary kits for a caramelizable composition, and exemplary caramelizable compositions.

### Exemplary Methods of Caramelizing a Composition

Caramelization may be defined as a method of browning a food composition to achieve a particular or desired color (e.g., a level of browning). For example, the color and/or level of browning may be determined by reflectance by or transmission of light (e.g., broadband visible light or one or more wavelengths or wavelength bands of visible light) through a sample or solution of the caramelized composition. It may also refer to a method in which the food composition is heated to increase the hardness and/or brittleness of the composition (e.g., in the substantial absence of water) and/or to increase the viscosity of the composition (e.g., when the composition includes added water and/or other liquid). Thus, the present caramelizing method may result in a caramel, a brittle, a syrup, a sauce, or another food product that includes a caramel, a brittle, a syrup and/or a sauce, as long as the caramel, brittle, syrup, sauce or food product (or food product component) is browned and/or thickened (i.e., its viscosity increased to a value consistent with the viscosity of a caramel, a brittle, a syrup, or a sauce) in a manner consistent with one or more aspects of the present description.

In one aspect, the present invention relates to a method of caramelizing a composition, comprising mixing a sugar alcohol and/or a non-metabolizable sugar and a dietary fiber to form a mixture, then heating the mixture to a temperature between 270° F. and 350° F. for a length of time sufficient to caramelize the mixture. In a “dry” method of caramelizing, the sugar alcohol and/or non-metabolizable sugar and the dietary fiber are mixed without water or other liquid (i.e., a substance or component that is in the piqued phase at ambient temperatures, such as 20-25° C.). The mixture is then heated to a temperature in the above range for a length of time to achieve the desired softness, pliability, brittleness, flavor, color and/or sweetness (typically, a desired and/or predetermined brittleness and/or level of browning). In another aspect, a “wet” method of caramelization is similar to the dry method, but with the additional step of adding water and/or another liquid (e.g., in a predetermined amount). In either the dry or wet method, a secondary sweetening agent (e.g., sweetening intensifier) such as those described herein may be added.

The sugar alcohol may be any 4- to 8-carbon polyol such as erythritol or xylitol, among others described herein. Thus, the sugar alcohol may have the chemical formula CₘH₂ₘ₊₂Oₙ, where m is an integer of from 4 to 8 (e.g., 5 or 6) and n is m or m−1 (e.g., m). The sugar alcohol may be caramelized by either the dry process or the wet process, in either case reducing any laxative effect of the sugar alcohol.

The non-metabolizable sugar may have from 5 to 12 carbon atoms and a conventional carbohydrate formula (i.e., CₐH₂ₐOₐ, where a is an integer of from 5 to 12 (e.g., 5, 6, 10, 11 or 12). A sugar may be characterized as non-metabolizable if it is generally recognized as being non-metabolizable, or if it is generally metabolized by humans at a rate of less than 20% of a generally-accepted rate of sucrose or glucose metabolism in humans (e.g., the rate of sucrose disappearance or glucose removal from blood in vivo in fasting humans, which may be a range). In further examples, the sugar may be non-metabolizable if it is metabolized by humans at a rate of less than 10% (or less than 5% or any other value less than 20%) of a generally-accepted rate of sucrose or glucose metabolism in humans.

The dietary fiber may comprise inulin or psyllium fiber. The inulin may be derived or obtained from Jerusalem artichokes and/or chicory root, among other sources. However, other fibers, such as fruit fibers and derivatives thereof including pectin and lignin, seaweed gums and derivatives thereof including carrageenan, agar and alginates, cellulose and derivatives thereof, cereal grain fibers including fiber from corn, wheat, oat, rice, barley or soy, fructans, fructooligosaccharides and derivatives thereof, seed gums including guar and locust bean gums, tree gums including karaya, tragacanth and acacia gums, xantham gum, vegetable fibers including gum Arabic and blue agave fiber, pea and other legume powders and fibers, and potato fiber. Generally, the dietary fiber is an oligo- or polysaccharide, poly(sugar acid) or poly(aminosugar) that may be linked or esterified with one or more inorganic or organic acids. In most embodiments, the dietary fiber is a polysaccharide (e.g., inulin, agar, cellulose, a hemicellulose, a fructan, a resistant starch, etc.) or a poly(sugar acid) (e.g., a pectin).

In one example, the mixture comprises erythritol and inulin. In other examples, the mixture comprises inulin and xylitol or a combination of inulin, erythritol and xylitol. In a further example, the mixture comprises allulose and inulin or a combination of allulose, erythritol and inulin. The sugar alcohol/non-metabolizable sugar (e.g., erythritol, xylitol and/or allulose) may be 5-99.9% by weight of the mixture. The dietary fiber (e.g., inulin) may be 0.1-99.9% by weight of the mixture. In one example, the mixture may comprise 100 parts by weight of inulin, 5-25 parts by weight of erythritol, and 5-25 parts by weight of allulose. Erythritol is known to stay soft and/or chewy at relatively high temperatures (e.g., at temperatures higher than those at which sucrose stays soft and/or chewy, in a caramel, a brittle and/or another food product such as a cookie) and tends to recrystallize at lower temperatures (e.g., at temperatures lower than those at which sucrose recrystallizes), whereas allulose shows thermal behavior similar to sucrose (e.g., no recrystallization at typical processing temperatures, a different softening-vs.-temperature curve than erythritol at relatively high temperatures. As a result, the balance of erythritol and allulose in the mixture may vary, depending on the desired outcome (e.g., properties of the caramel, brittle, syrup, sauce or other food product).

The sugar alcohol/non-metabolizable sugar-to-dietary fiber ratio in the mixture depends on the application for which the mixture is used. The ratio of sugar alcohol/non-metabolizable sugar to dietary fiber may be by weight or by volume. In one range of ratios (e.g., from 30:70 to 70:30, or any ratio or range of ratios therein), the mixture may be suitable for the dry method (e.g., to make a caramel, a brittle, a bar or bite containing nuts and/or grains, candy, etc.). In another range of ratios (e.g., from 20:80 to 50:50 of sugar alcohol/non-metabolizable sugar to dietary fiber, or any ratio or range of ratios therein), the mixture may be used to make a syrup or a product including the syrup (e.g., a baked good such as cookies, cakes, breads, muffins, pastries, etc.).

The method generally involves mixing the components (i.e., at least the sugar alcohol and/or non-metabolizable sugar and the dietary fiber) and heating the mixed components to a predetermined temperature. For example, the components may be mixed by hand or in an electric/industrial mixer or blender (e.g., a ribbon, paddle, vertical or tumble blender, or a high-shear, planetary or shaft blender [e.g., for liquid-containing mixtures]), and heated on a sheet or belt, or in a pot, pan, kettle or other vessel, at medium heat (e.g., using a gas or electric heat source), then cooling the heated composition to room temperature. The components may be mixed prior to heating, or mixed and heated simultaneously. Depending on the amount of the mixture being heated, the heating rate may be in the range 1-100° F./minute or 1-50° C./minute, and the heating rate may be varied in phases. For example, the mixture may be heated at a rate of 20-100° F./minute or 10-50° C./minute in a first phase (e.g., the first 1-10 minutes of heating), then at a lower rate (e.g., 1-20° F./minute or 1-10° C./minute) in a second phase (e.g., the next 5-20 minutes of heating). Additional heating rates and lengths of time for additional phases can be easily envisioned by those skilled in the art. Variants of the method further include separating (e.g., cutting, chopping and/or portioning) the heated or cooled composition, packaging the heated composition (before or after cooling), etc.

Various temperatures or temperature ranges during heating may achieve different levels of browning the blend. For example, in the dry method, heating to a temperature of 270° F. to 350° F. (e.g., 130-175° C.) generally results in some level of browning and some brittleness (e.g., imparted to the cooled mixture post-heating). In some embodiments, at temperatures above 320° F. (e.g., 320-350° F., or 160-175° C.), the brittleness of the cooled mixture post-heating may be less than that of a mixture heated in the range of 270° F. to 320° F. (e.g., 130-160° C.), but some brittleness is still imparted. Above 350° F. (177° C.), brittleness may not be imparted to the cooled mixture. This brittleness behavior above 320° F. (160° C.) distinguishes the present invention from otherwise identical methods and compositions that use table sugar (sucrose).

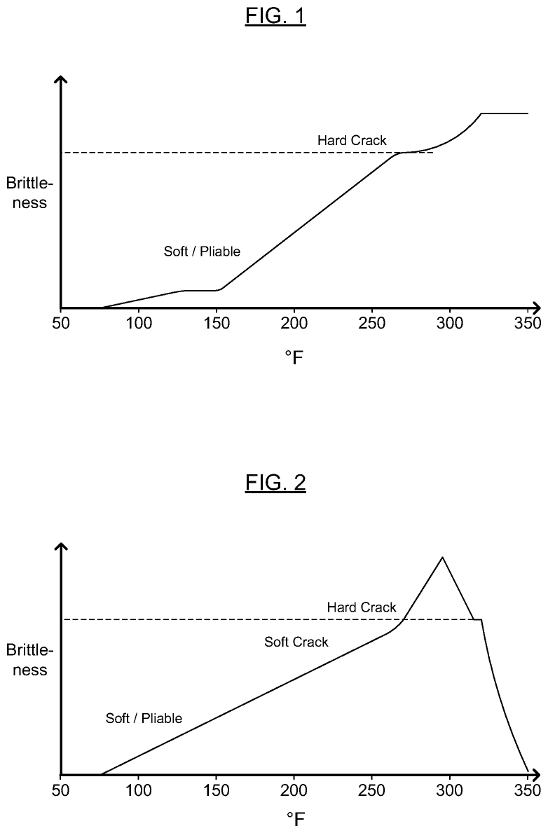

For example, FIG. 1 is a graph that represents the brittleness of a caramel made from granulated table sugar (sucrose), heated to a certain temperature for at least a period of time sufficient to liquify the sucrose (or bind the granules of sucrose together if a melting or liquifying temperature was not reached), then cooled to room temperature. Below about 150° F. (65° C.), the mixture arguably did not form a caramel, and the cooled mixture was relatively soft and pliable. Below about 270° F. (132° C.), the caramel was still soft and pliable, but the brittleness (e.g., the force necessary to bend a flat piece of the caramel or break a single piece of the caramel into separate pieces) increased (at least somewhat linearly) with temperature. At about 270° F. (132° C.), a transition occurred in which the soft and pliable caramel became hard, and application of a bending force to a flat piece of the caramel consistently resulted in cracking or breaking (e.g., into separate pieces), often without noticeable bending. Between about 270° F. (132° C.) and about 320° F. (160° C.), the brittleness of the caramel increased exponentially, up to a heating temperature of about 320° F. (160° C.). Above about 320° F. (160° C.), the brittleness of the caramel did not noticeably change.

FIG. 2 is a graph that represents the brittleness of a caramel made from a 50:50 mixture of erythritol and inulin, heated to a certain temperature for at least a period of time sufficient to liquify the erythritol and inulin (or bind the granules or particles of erythritol and inulin together if a liquifying temperature was not reached), then cooled to room temperature. Below about 150° F. (65° C.), the cooled mixture was relatively soft and pliable. Between about 150° F. (65° C.) and about 270° F. (132° C.), the caramel was still soft and pliable, but at a certain bending force above that necessary to bend a single piece of the caramel, the caramel underwent an incomplete and/or non-uniform break (a so-called “soft crack”). At about 270° F. (132° C.), a transition occurred in which the caramel becomes hard, and application of a bending force to a flat piece of the caramel consistently results in cracking or breaking (e.g., into separate pieces), often without noticeable bending. Between about 270° F. (132° C.) and about 320° F. (160° C.), the brittleness of the caramel increased to a maximum at about 295-300° F. (146-149° C.), then decreased. Above about 320° F. (160° C.), the caramel became soft again, and the brittleness transitioned back to pliability, rapidly decreasing to near zero at about 350° F. (177° C.).

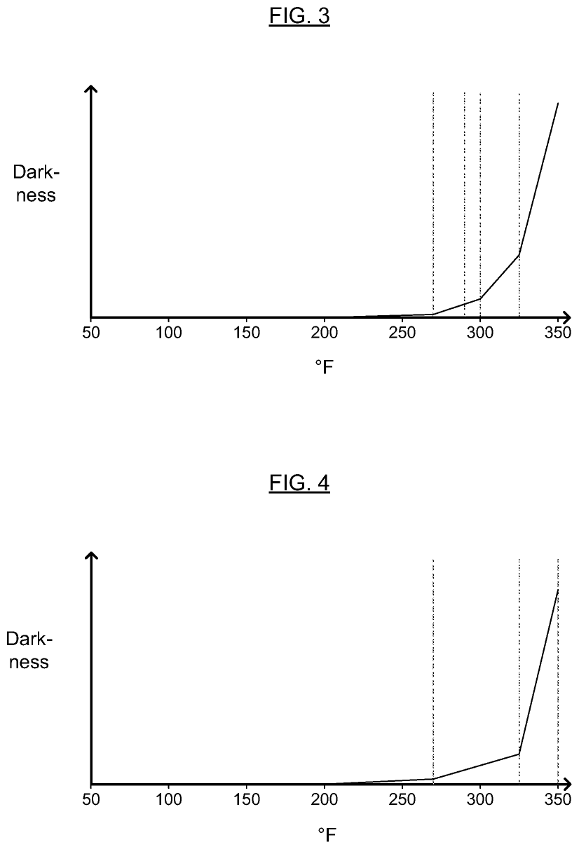

FIG. 3 is a graph that represents the darkness or color of a caramel made from a 50:50 mixture of erythritol and inulin, heated slowly from room temperature to 350° F. (177° C.). Below about 200° F. (93° C.), the mixture was somewhat milky or cloudy, and has an off-white color. Below, but close to, about 270° F. (132° C.), the caramel acquired a light yellow color. At about 270° F. (132° C.), the yellowness of the caramel began to increase, and any cloudiness or milkiness in the caramel disappeared. At 290° F. (143° C.), the caramel acquired a readily evident yellow color, and the yellow color of the caramel continued to darken steadily up to a temperature of about 300° F. (149° C.). At about 300° F. (149° C.), the change of color (e.g., increase in darkness) increases more rapidly, and at about 325° F. (163° C.), the caramel acquires an amber color generally associated with a caramel. The darkness continues to increase rapidly up to a heating temperature of about 350° F. (177° C.). At temperatures approaching 350° F. (177° C.), the caramel acquired a dark amber color. Color testing was stopped above 350° F. (177° C.), as the caramel lost substantially all brittleness and began to burn above this temperature (i.e., at temperatures greater than 365° F. [185° C.]).

FIG. 4 is a graph that represents the darkness or color of a caramel made from table sugar, heated in the same manner as the erythritol and inulin mixture described with respect to FIG. 3. Between about 200° F. (93° C.) about 325° F. (163° C.), the caramel has a clear to pale yellow color, largely without any cloudiness or milkiness. At about 325° F. (163° C.), the color of the caramel darkened rapidly, up to a heating temperature of about 350° F. (177° C.). The flavor of the caramel also intensified over the range of about 325° F. (163° C.) to about 350° F. (177° C.).

Thus, the present method enables formation of a soft or pliable caramel having a dark amber color, a result not possible with table sugar alone. Furthermore, when heating below temperatures of about 320-325° F. (160-163° C.), the present method enables formation of a slightly darker caramel having a brittleness similar to a caramel made from sucrose using the same methodology. However, the browning behavior of the sugar alcohol/non-metabolizable sugar and dietary fiber in the present method is similar to that of sucrose in otherwise identical methods, although there are relatively minor variances in the browning and brittleness behavior of the sugar alcohol/non-metabolizable sugar and dietary fiber mixture, depending on the exact components used, their proportion(s), the presence/absence of water (and if present, the amount or proportion), etc. In some embodiments, depending on the exact blend or proportion of components in the mixture, the mixture of components (i.e., at least the sugar alcohol and/or non-metabolizable sugar and the dietary fiber) may be heated to a temperature of 365° F. or more without excessive bitterness being imparted to the caramel.

The wet method further comprises mixing water and/or another liquid (e.g., a fat and/or oil) with the sugar alcohol/non-metabolizable sugar and the dietary fiber. From 1 part to 50 parts (e.g., from 5 to 20 parts, 8 to 15 parts, etc.) of water and/or other liquid may be added per 100 parts of the mixture, by weight or volume. In one example, about 12 parts of water are mixed with 100 parts of the mixture of sugar alcohol/non-metabolizable sugar and dietary fiber. In other examples, the other liquid may be or comprise butter, margarine or a vegetable oil. For convenience in manufacturing, parts by weight of water and/or other liquid is added to parts by weight of the mixture. Furthermore, some degree of caramelization (particularly, an increase in viscosity) occurs in the wet method at temperatures as low as 180-200° F. (82-93° C.). At temperatures above 200° F. (93° C.), some water is lost in the wet method due to evaporation, and the viscosity of the mixture perceptibly increases. In the wet method, the amount or proportion of water and/or other liquid in the final product (e.g., syrup) may vary (e.g., depending on the length of heating time), but can be determined by testing.

The method may further comprise adding an organic acid (as described herein, such as citric acid or tartaric acid) to improve the binding properties, humectant properties, taste (e.g., “sharpness”), nutritional value (e.g., antioxidant properties) and/or shelf life of the caramel or syrup. Suitable natural flavorings can also be added to the mixture, including but not limited to nuts, green vegetables and legumes, carrots, chocolate, cocoa, vanilla, orange, lemon, lime, grapefruit, peach, apricot, nectarine, strawberry, blueberry, raspberry, peppermint, coffee, cinnamon, mocha, tomato, herbs (green tea, ginger, ginseng, etc.) and the like.

### Exemplary Kits for Caramelizing a Composition

In another aspect, the present invention relates to a kit for making a caramelizable composition, comprising a container containing (i) a sugar alcohol and/or a non-metabolizable sugar and (ii) a dietary fiber in a ratio by weight or by volume such that a mixture of the sugar alcohol and the dietary fiber is caramelized when heated to a temperature of from 270° F. to 350° F. for a sufficient length of time to caramelize the mixture.

The sugar alcohol, non-metabolizable sugar and dietary fiber may be selected from those suitable for use in the present method(s), and they may be present in any ratio suitable in the present method(s). The temperature at which the mixture caramelizes may be from 270° F. to 320° F. (e.g., 130-160° C.), from 290° F. to 350° F. (e.g., 143-175° C.), from 300° F. to 325° F. (e.g., 145-163° C.), or any temperature or range of temperatures in the range from 270° F. to 350° F. (e.g., 130-175° C.). As described elsewhere herein, some embodiments of the mixture (e.g., those further including water and/or another liquid) may caramelize at a temperature below 270° F., but they will also caramelize at 270° F. or higher.

The composition may be in powdered, granular, or liquid form. In powdered or granular form, the composition may be used for producing confectionery products, beverages, baked goods, snack bars and similar products. In liquid form, the composition is used to produce confectionery products, baked goods such as bread, snack bars and similar products.

The kit may further comprise a foodstuff in the container. For example, the foodstuff may comprise one or more nuts, grains, and/or fruits. In such examples, the kit may be suitable for making a brittle or snack bars. Alternatively, the foodstuff may comprise flour, dry eggs, a dry dairy product, a flavoring agent, a fat, or an oil. In such examples, the kit may be suitable for making bread, a cake, muffins, etc. When the foodstuff includes flour, the kit may further comprise yeast, salt (sodium chloride), baking soda, baking powder, etc. In addition to other flavoring agents disclosed herein, the flavoring agent may be a spice such as cinnamon, allspice, nutmeg, ground cloves, paprika, black or white pepper, cayenne pepper, etc. When the foodstuff is a fat or oil (e.g., butter, shortening, lard, vegetable oil, peanut oil, olive oil, coconut oil or medium-chain triglyceride [MCT] oil, which may be in a solid, powder, or liquid form), the kit may further comprise an emulsifying agent. In combination with one or more fruits and/or nuts, the kit containing an alternative foodstuff may be suitable for making candy, yogurt, and other products. The kit may also include a sweetening intensifier and/or an organic acid, as described above for the present method(s).

In some embodiments of the present kit, the sugar alcohol and/or non-metabolizable sugar may be in one package, and the dietary fiber and the foodstuff may be in a separate package in the container. This may be advantageous when packaging different components or different amounts of components for different kits having different purposes or intended uses. For example, a kit for a caramel may include roughly equal amounts of the sugar alcohol/non-metabolizable sugar and the dietary fiber, whereas a kit for a syrup may include roughly twice as much of the dietary fiber as the sugar alcohol/non-metabolizable sugar. Packaging appropriate amounts of the sugar alcohol/non-metabolizable sugar and the dietary fiber separately enables a simplified process for making the kits.

In embodiments further comprising a foodstuff, the foodstuff may be in a package separate from the sugar alcohol/non-metabolizable sugar and the dietary fiber. For example, when the sugar alcohol/non-metabolizable sugar and the dietary fiber are in one package (e.g., combined as a mixture), the foodstuff may be in one or more separate packages, depending on the foodstuff(s) and their compatibility with each other. Alternatively, the sugar alcohol/non-metabolizable sugar may be in a first package, the dietary fiber may be in a second package, and the foodstuff(s) may be in one or more third packages.

The container may comprise a box, a tin, a bag, a jar or a bottle. The box may comprise paperboard, cardboard (e.g., corrugated paperboard), plastic, or a combination thereof. The tin may comprise metal (e.g., a metal tray and a metal lid). The box may also comprise a tray with a separate or attached lid, although any kind of box is suitable. The bag may comprise paper, plastic or a combination thereof, and when the bag is plastic, it may further comprise a metal layer evaporated thereon. The jar or bottle may comprise plastic, glass or a combination thereof, and may have a lid or cap thereon. The lid or cap for the jar or bottle may comprise plastic, metal, wood (e.g., cork), or a combination thereof, and may be tightly sealed to the body of the jar or bottle. In suitable embodiments, the packages inside the container may also be or comprise a box, a tin, a jar or a bag as described herein, although plastic and/or paper bags are particularly suitable.

### Exemplary Products Including a Caramelized Composition

A further aspect of the invention are food products resulting from the caramelization of the composition(s) disclosed herein. Products including caramels, syrups, and an assortment of foodstuffs are realized as a result. The present food product comprises a caramelized composition as disclosed herein (e.g., comprising a sugar alcohol and/or a non-metabolizable sugar and a dietary fiber). The caramelized composition has a level of browning and/or a brittleness associated with an otherwise identical caramelized composition including an amount of sucrose equivalent to amounts of the sugar alcohol and/or non-metabolizable sugar and the dietary fiber in the caramelized composition. For example, the level of browning of the caramelized composition is at least 50% (e.g., 75%, or any other minimum value greater than 50%) of the otherwise identical caramelized composition. Additionally or alternatively, the brittleness of the caramelized composition is at least 50% (e.g., 75%, or any other minimum value greater than 50%) of the otherwise identical caramelized composition.

In general, the caramelized composition provides a similar sweetness to that of the otherwise identical caramelized composition. Thus, when determining the amount of sucrose in the otherwise identical caramelized composition equivalent to amounts of the sugar alcohol and/or non-metabolizable sugar and the dietary fiber in the caramelized composition, the amount of sucrose in the otherwise identical caramelized composition may be an amount providing a sweetness equivalent or equal to a sweetness of the amounts of the sugar alcohol/non-metabolizable sugar and the dietary fiber in the caramelized composition. Alternatively, the amount of sucrose in the otherwise identical caramelized composition is equal to an amount of the sugar alcohol/non-metabolizable sugar and the dietary fiber in the caramelized composition by volume or weight.

In some examples, the present food product comprises a brittle. The brittle comprises a caramel in accordance with the present invention and one or more nuts, grains, and/or fruits (e.g., chopped nuts, whole nuts, whole grains, chopped dry fruits and/or whole dry fruits). Alternatively or additionally, the present food product may comprise a foodstuff selected from flours, eggs, dairy products, fruits, nuts, flavoring agents, fats, and oils. When the foodstuff includes flour, the food product may be a baked good, and the food product may further include salt, baking soda, baking powder, one or more nuts and/or fruits, one or more flavoring agents, etc., as discussed herein. When the foodstuff includes a fat and/or oil, the food product may further include an emulsifying agent. When the foodstuff includes eggs or a dairy product (e.g., milk, cream, cheese, butter, whey, yogurt, etc.), the foodstuff may be whole, dried or powdered.

### Exemplary Sauce Compositions

Yet another aspect of the present invention relates to a caramelized sauce, comprising (i) a sugar alcohol and/or a non-metabolizable sugar, (ii) a dietary fiber, (iii) water, and (iv) one or more thickeners, colorants and/or flavoring agents adapted to impart one or more characteristics of caramelization to the caramelized sauce. The sugar alcohol, non-metabolizable sugar and dietary fiber are as described elsewhere herein. The sugar alcohol and/or non-metabolizable sugar and the dietary fiber may be present in amounts such that the ratio by weight or by volume of (i) the sugar alcohol and/or non-metabolizable sugar to (ii) the dietary fiber is as described elsewhere herein (e.g., from 1:99 to 99:1 or any value or range of values therein, such as from 10:90 to 90:10).

The caramelized sauce may be further characterized as having a density and/or viscosity less than that of a syrup, but greater than that of water. For example, water has a density of 1.0 g/ml and a viscosity at 20° C. of about 31 SSU (about 1 cP). A syrup may have a density of from about 1.25 g/ml to about 1.80 g/ml (or any value or range of values therein, such as 1.30-1.60 g/ml) and a viscosity of at least 2000 SSU (about 65 cP, or any other minimum value of at least about 65 cP, such as 75 cP, 80 cP, 100 cP, etc.). A sauce may thus have a density of from 1.01 to about 1.25 g/ml (or any value or range of values therein) and a viscosity of from 1.1 to about 80 cP. While there may or may not be some overlap in the viscosity ranges for a syrup and a sauce, there generally is no overlap in the density ranges for a syrup and a sauce (except at a transition point or range, such as 1.25 g/ml or about 1.25 g/ml).

The present sauce (and the present syrup) may be characterized by their degrees Brix and/or Baumé. The Brix scale measures the sugar density of a liquid, whereas the Baumé scale measures the specific gravity of a solution (in the present case, the ratio of the density of the sauce or syrup to the density of water). The present sauce may thus have a value of 10-80 degrees Brix (or any value or range of values therein) or of 5-46 degrees Baumé (or any value or range of values therein). A high-degree Baumé or Brix concentrated syrup (e.g., 30-45 degrees Baumé or 60-75 degrees Brix) prepared in accordance with the present invention may be used as a substitute for corn syrup (e.g., high fructose corn syrup) or glucose-based syrups.

The thickeners, colorants and/or flavoring agents adapted to impart one or more characteristics of caramelization to the caramelized sauce are conventional, and may be present in amounts of from 0.0001% to 10% (or any value or range of values therein) by weight or volume. Additional food ingredients, such as fruit (e.g., purees of apples, peaches, mangoes, plums, apricots, cherries, blueberries, blackberries, raspberries, pumpkins, tomatoes, etc.), vegetables (e.g., carrots, squash, potatoes, yams, onions, garlic, purees thereof, etc.), dairy products (e.g., yogurt, milk, condensed milk, cream, ice cream mix, etc.), grains (e.g., rice, wheat, barley, oats, millet, flours thereof, etc.), oils and/or fats (e.g., vegetable oil, olive oil, sesame oil, butter, margarine), etc. may be added to the present sauce (or vice versa) to provide a caramelized and/or thickened food product, although an oil or fat will generally lower the density of the sauce relative to a purely water-based sauce. Thus, the present invention also encompasses related products, such as juices, concentrates, jellies and sweetened condensed milk, that are caramelized and/or thickened using the mixture of (i) the sugar alcohol and/or non-metabolizable sugar and (ii) the dietary fiber.

### Exemplary Methods of Making a Sauce

The present invention also concerns a method of making a caramelized and/or thickened sauce, which may comprise combining (i) a sugar alcohol and/or a non-metabolizable sugar, (ii) a dietary fiber, (iii) water, and (iv) one or more thickeners, colorants and/or flavoring agents adapted to impart one or more caramelization characteristics to the sauce, then heating the combined ingredients to a temperature and for a length of time sufficient to make the sauce. The sauce may have a density and/or viscosity less than that of a syrup, but greater than that of water. The method may further comprise adding one or more food ingredients as described herein to the sauce or component(s) thereof, generally (but not necessarily) before heating.

On a large scale, the method is typically conducted in a commercial sauce making plant. The sauce making plant may comprise a washing machine (e.g., for washing the food ingredient[s]), a sorting machine, a peeling machine, one or more belt and/or slat conveyors, a crusher, a fruit mill, a pulveriser, a kettle (e.g., having a capacity of about 200 liters or more), a fryer or frying pan, a pulping machine, an evaporator (e.g., a vacuum evaporator), a pasteurizer, and/or an aseptic storage and/or container-filling system. Thus, the method of making a sauce may further comprise washing one or more food ingredients (e.g., fruit, vegetables, purees thereof, liquids such as water, milk, cream, oil, etc.), sorting the food ingredient(s) (e.g., according to size, shape, quality, etc.), conveying the food ingredient(s), other components of the sauce and/or the sauce itself (e.g., between pieces of equipment in the plant), crushing the food ingredient(s), milling the food ingredient(s) (e.g., when the food ingredient[s] comprise one or more fruits), pulverizing the food ingredient(s), heating the sugar alcohol/non-metabolizable sugar, dietary fiber, water, thickener(s), colorant(s), flavoring agent(s) and/or food ingredient(s) in the kettle, heating and/or the sugar alcohol/non-metabolizable sugar, dietary fiber, water, thickener(s), colorant(s), flavoring agent(s) and/or food ingredient(s) in the fryer or frying pan, pulping the food ingredient(s) and/or the sauce, evaporating some of the water from (and, optionally, applying a vacuum to) the sauce, pasteurizing the food ingredient(s) and/or the sauce (e.g., either before or after heating the sauce), aseptically storing the sugar alcohol/non-metabolizable sugar, dietary fiber, water, thickener(s), colorant(s), flavoring agent(s) and/or food ingredient(s), and/or filling containers with the sauce.

Most caramel sauce manufacturing equipment (e.g., the kettle) can reach a maximum temperature of about or slightly above the boiling point of water (e.g., about 220° F. or 105° C.), which can caramelize the sugar and/or other carbohydrates in the caramel sauce mixture. However, to achieve certain desired properties, caramel sauce manufacturers typically add caramel color, one or more thickeners, one or more caramel flavoring agents, etc. As a result, in one embodiment, the present method makes a caramel sauce, and typically includes (but does not necessarily require) adding caramel color, one or more thickeners (e.g., a starch, pectin, gelatin, etc.), and/or one or more caramel flavoring agents to the components of the caramel sauce during its preparation and/or manufacture.

### CONCLUSIONS

The present invention concerns a no- or low-calorie caramel or syrup that replaces the sugar (sucrose) in conventional caramels and syrups and that has little or no aftertaste and a sweetness similar or equal to that of conventional sugar-containing caramels and syrups. It may include all natural ingredients, depending on the application and the amounts of sugar alcohol/non-metabolizable sugar and dietary fiber used. Embodiments of the invention may be used in baking cakes, cookies, bars, shakes, pastries, ice cream, and desserts, and can substitute for most beet sugar or cane sugar applications. The present invention is also useful as a sugar substitute in applications where sugar (e.g., caramelized sugar) is used as a stabilizer and is cooked to a “soft or medium ball” in products such as mousses, Bavarians and meringues.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for preparing a caramelized product comprising:
a) mixing (i) a sugar alcohol and/or a non-metabolizable sugar and (ii) a dietary fiber to form a mixture; and
b) heating the mixture at a temperature and for a length of time sufficient to caramelize the mixture.

2. The method of claim 1, comprising mixing the sugar alcohol and the dietary fiber.

3. The method of claim 1, comprising mixing the non-metabolizable sugar and the dietary fiber.

4. The method of claim 1, wherein the temperature is from 270° F. to 350° F.

5. The method of claim 1, wherein the mixture contains the sugar alcohol and/or the non-metabolizable sugar and the dietary fiber in a weight or volume ratio of from 10:90 to 90:10 of (i) the sugar alcohol and/or the non-metabolizable sugar to (ii) the dietary fiber.

6. The method of claim 1, wherein the sugar alcohol and/or non-metabolizable sugar and the dietary fiber are mixed without water or other materials that are liquid at room temperature.

7. The method of claim 1, wherein the sugar alcohol and/or the non-metabolizable sugar and the dietary fiber are further mixed with water and/or another liquid to form the mixture.

8. A kit for a caramelizable composition, comprising:
a) a container;
b) a sugar alcohol and/or a non-metabolizable sugar in the container; and
c) a dietary fiber in the container,
wherein the sugar alcohol and/or non-metabolizable sugar and the dietary fiber are present in amounts such that a ratio by weight or by volume of the sugar alcohol and/or non-metabolizable sugar to the dietary fiber forms a mixture that, when heated to a temperature of from 270° F. to 350° F. for a sufficient length of time, is caramelized.

9. The kit of claim 8, comprising the sugar alcohol.

10. The kit of claim 8, comprising the non-metabolizable sugar.

11. The kit of claim 8, consisting essentially of the sugar alcohol and/or non-metabolizable sugar and the dietary fiber, wherein a ratio of an amount of the sugar alcohol and/or the non-metabolizable sugar to an amount of the dietary fiber is from 30:70 to 70:30 by weight or volume.

12. The kit of claim 8, further comprising a foodstuff in the container.

13. The kit of claim 8, wherein (i) the sugar alcohol and/or non-metabolizable sugar and the dietary fiber and (ii) the foodstuff are in separate packages in the container.

14. A food product comprising a caramelized composition, the caramelized composition comprising (i) a sugar alcohol and/or a non-metabolizable sugar and (ii) a dietary fiber, wherein the caramelized composition has a viscosity, a level of browning and/or a brittleness associated with an otherwise identical caramelized composition including an amount of sucrose equivalent to amounts of the sugar alcohol and/or non-metabolizable sugar and the dietary fiber in the caramelized composition.

15. The food product of claim 14, wherein the level of browning of the caramelized composition is at least 50% of the otherwise identical caramelized composition.

16. The food product of claim 14, wherein the brittleness of the caramelized composition is at least 50% of the otherwise identical caramelized composition.

17. The food product of claim 14, wherein the amount of sucrose in the otherwise identical caramelized composition is an amount providing a sweetness equivalent or equal to a sweetness of the amounts of the sugar alcohol and/or non-metabolizable sugar and the dietary fiber in the caramelized composition.

18. The food product of claim 14, wherein said caramelized composition comprises a caramel, a syrup, or a baked good.

19. A caramelized sauce, comprising:
a) a sugar alcohol and/or a non-metabolizable sugar,
b) a dietary fiber,
c) water, and
d) one or more thickeners, colorants and/or flavoring agents adapted to impart one or more characteristics of caramelization to the caramelized sauce.

20. A method of making the caramelized sauce of claim 19, comprising
a) combining (i) the sugar alcohol and/or non-metabolizable sugar, (ii) the dietary fiber, (iii) the water, and (iv) the one or more thickeners, colorants and/or flavoring agents, then
b) heating the combined ingredients to a temperature and for a length of time sufficient to make the sauce.
